(19) United States
(12) Patent Application Publication
(10) Pub. No.: US 2008/0091357 A1
(43) Pub. Date: Apr. 17, 2008

(54) Method to identify epitopes

(75) Inventors: Noriyuki Sasaki, Woodland Hills, CA (US); Rene Castro, Los Angeles, CA (US)

Correspondence Address: Cislo & Thomas LLP, 1333 2nd Street, Suite #500, Santa Monica, CA, 90401-4110, US

(73) Assignee: One Lambda, Inc.

(21) Appl. No.: 11/546,608

(22) Filed: Oct. 12, 2006

(51) Int. Cl. G06F 19/00

(52) U.S. Cl. 702/19

(57) ABSTRACT

The present invention is directed to methods, computer software and assay kits to identify epitopes, such as HLA epitopes. The preferred method comprises steps of constructing data tables of possible polymorphic sites of epitopes defined by a single antigen product, such as single antigen beads and, for a given string of specificities, searching the data table and presenting a list of possible single residues to explain the reactions. The methods, assay kits and computer software disclosed herein may also include an option for users to specify which positions or which paired positions to exclude and other parameters may be used to reduce the number of possible epitopes. In addition a graphical interface, such as a three-dimensional graph, may be included to permit easier selection from the multiple possibilities.

### BACKGROUND OF THE INVENTION

1. Field of the Invention

This invention relates to methods, computer software and assay kits useful in identifying epitopes, such as human leukocyte antigen (“HLA”) epitopes, and antibody specificities.

2. Description of the Related Art

The human leukocyte antigen (“HLA”) system is the general name of a group of genes in the human histocompatibility complex (MHC) region of human chromosome 6 that encodes the cell surface antigen-presenting proteins. The HLA system presents the most extensive allelic polymorphism of all human genes. This diversity is the likely result of positive evolutionary selection correlated with improved fitness to respond to different antigens.

Epitopes on the HLA molecule are of particular importance because they are the molecular sites against which HLA antibodies are produced and therefore the targets of the response to incompatible organ transplants. In addition, donor T-cell recognition of host HLA can give rise to graft-versus-host disease. Therefore, selection of a donor with the fewest mismatches to the recipient is critical in reducing post-transplantation complications. Because HLA antigens are polymorphic, however, the chance of perfectly matching a particular transplant recipient and a particular donor is rare and the immune system will respond to mismatches of HLA proteins. In general, the number of mismatched alleles determines the speed and magnitude of the rejection response. See e.g., Charles G. Mullighan and Efffie W. Petersdorf, “Genomic Polymorphism and Allogenic Hematopoietic Transplantation Outcome”, Biology of Blood and Marrow Transplantation 12:19-27 (2006). In addition, Mullighan et al. recognized that existing protocols for matching donors and recipients may unnecessarily limit the donor pool available for potential recipients because certain allelic mismatches may be permissible without comprising outcome.

Therefore, various tests and methods have been employed to evaluate HLA antibody specificities (antigens). From the observed specificities, many attempts were made to deduce the HLA epitopes that produce the observed HLA specificities. More recently, development of single antigen products, such as single antigen beads, has made it possible to see the specificities (antigens) against which antibodies are directed. More particularly, single antigen beads, or other single antigen products, have been employed to identify the absence or presence of an antibody against a specific allele, without being masked by other alleles. A positive reaction for a particular single antigen bead or product indicates the presence of the antibody against the specific allele/antigen to which the bead is attached.

One continuing problem in determining epitopes, such as HLA epitopes, from observed specificities, however, is the large volume of data that needs to be sifted through and analyzed. For example, as of July 2006, according to the HLA nomenclature list published by the Anthony Nolan Trust HLA Informatics Group (www.anthonynolan.org.uk/HIG/), 479 A Locus and 805 B Locus HLA alleles have been found. Including all of these 1200 plus alleles makes it nearly impossible to deduce the epitope from the observed specificities.

Therefore, there is a need for a practical and reliable method to identify epitopes, such as HLA epitopes, and for analyzing observed antibody specificities for probable epitopes.

### SUMMARY OF THE INVENTION

The present invention includes methods, computer software and assay kits for identifying epitopes, such as HLA epitopes, and for analyzing observed antibody specificities for probable epitopes. In one aspect of the present invention, an observed positive reaction pattern resulting from reaction of single antigen beads, or other single antigen products, and the reaction strength for each bead are employed to determine the possible number of antibodies and the specificities for each antibody. The use of is single-antigen products, such as single antigen beads, permits determining the presence of a specific allele without masking by other alleles. For example, Pei et al. describe methods to identify HLA antibody specificities using single HLA flow cytometry beads (“Single Human Leukocyte Antigen Flow Cytometry Beads for Accurate Identification of Human Leukocyte Antigen Antibody Specificities”, Rui Pei, Jar-How Lee, Neng-Jen Shih, Mike Chen and Paul Terasaki, Transplantation, Vol. 75, 43-49 No. 1 (January 2003), hereby incorporated in its entirety).

The term “specificity” as used herein includes antibody specificity in terms of antigens or alleles, such as for example, HLA antigens or alleles. According to one aspect of the present invention, specificities are deduced by associating positive reactions from the single antigen bead, or other single antigen product, test with their assigned antigens/alleles. In the case of using the single-antigen bead test, each of the beads is coupled with a single antigen/allele so that a positive reaction of the bead indicates the presence of the antibody against the particular antigen/allele. FIG. 2(a) shows an example of the reaction strength derived from a sample for single antigen bead testing for HLA antigens or specificities A1, A11, A24, A3, A36, A80, A30 and A31. FIG. 2(b) shows the output of specificities and positions/amino acids that were identified as the epitope. FIG. 2(c) shows the relative position of the epitope on the HLA molecule.

As used herein, the term “epitope” includes the molecular site that an antibody can recognize and with which it is able to attach, i.e., a portion of an antigenic macromolecule recognized by and/or bound by a specific antibody and the positions, or combination of positions, on the HLA molecule, or other molecule, against which antibodies are produced. For example, FIG. 1 shows different antibody specificities that will react with the designated epitopes.

The present invention is also directed to novel data reduction methods and antibody grouping processes to determine antibody specificities and the associated epitopes. In one aspect of the invention, single-antigen beads or other single antigen products are utilized in a novel method for determining antibody specificities. In another aspect of the invention, probable epitopes for a given sample are determined by a novel method employing data tables constructed of all possible epitopes and derived from examination of all possible variations in the amino acid sequence of the antigens in question.

By way of example, within the commonly recognized region of the HLA molecule, there are about 300 amino acid sites, which might be an epitope, or part of an epitope. In order to see which of these potential epitopes are HLA epitopes, a table may be built of these potential new epitopes and charted with the specificities recognized by each epitope. However, including all of the 1200 plus alleles published by the Nolan Trust on a table would make it nearly impossible to deduce the epitope from the observed specificities. By using the results obtained from the single antigen product and by use of the novel methods described herein, however, the instant invention permits reduction of the amount of data by limiting the number of alleles to only those present on the single antigen product.

Continuing with HLA as an example, the above-mentioned 300 or so amino acid sites can further be reduced to only those positions that are able to discriminate some of the 77 alleles and those associated with variable amino acids within the 77 alleles. With this reduction, the number of sites which need to be included decreases to 84 positions. (see e.g., FIGS. 3-4). 290 combinations of single-position specific amino acids are found for these 84 variable positions (see e.g., FIGS. 5-14). A table of the potential two-position epitopes may be created, from the 290 single-entry table by combining two of these tables. Further data reduction may be performed by eliminating combinations of more than 40 amino acids apart, combinations that do not cover any more specificities than either of the combined two tables, and those that do not cover any specificities.

In the past, observed specificities were only useful for detecting some of the possible specificities. Specificities were derived from observing the presence of positive reactions in a test sample and their associated alleles. As with the traditional antibody detection products, where more than one allele was associated with a specificity, specific associations to any given allele could not be determined with any certainty. Using single antigen products or single antigen beads, however, avoids this masking effect. With single antigen products or beads, different beads will contain a different antigen with varying concentration. A positive reaction will therefore yield a different response, such as for example, in MFI (mean fluorescence intensity), or fluorescence intensity.

Using the average values of the MFI (or other measurement) of positive control samples, an adjustment factor may be computed to equalize, for example, the fluorescence intensity of all the beads. This computation may also be carried out using median fluorescence, trimmed mean, or other values. Because different beads may also have variable background, the fluorescence values (or other measured values) obtained from negative control samples may be measured to subtract background. Sample specific background may be measured on a NC (negative control) bead (most of the time designated as bead 001) to measure sample-specific background value against beads. After preferably having all three variations normalized, the results from the sample are ready to be processed. Bead or other products employing molecules of equivalent soluble fluorochrome (MESF) may also be used, and the reaction strength expressed as a MESF value or normalized percent value defined by MESF values derived from positive and negative control samples (see for example, L. Wang, K. Gaigalas, F. Abbasi, G. Marti, R. Vogt and A. Schwartz, “Quantitating Fluorescence Intensity from Fluorophores: Practical Use of MESF Values”, J. Rsch. Nat'l Standards and Technology, Vol. 107, No. 4 (2002) incorporated herein by reference).

After normalization, a bar graph may be constructed of the resulting MFI (or other measure value) for each bead or other single antigen product. The results may be ordered from high to low, to form a step formation. Each group of beads forming a step is considered to be an antibody. The endpoint of the very last step will preferably be adjusted, depending upon fitness to an associated data table. Next, the specificity of each antibody to its epitope is determined. The specificity associated with each of the beads (or other single antigen product) within each group are combined to form a specificity list, which is compared to those compiled in the table (see e.g., FIGS. 24-28). The location and specific amino acid are considered to be the possible HLA epitope. If no match is found, the results are further analyzed to determine whether the results are due to the presence of multiple antibodies forming one group (see e.g., FIGS. 24-28). For the last group, the endpoint adjustment may be made to include an additional bead and specificity if there is no match found in the table.

### OBJECTS OF THE INVENTION

It is an object of the present invention to provide methods, kits and computer software programs for determining epitopes, such as HLA epitopes. These and other objects and advantages of the present invention will be apparent from a review of the following specification and accompanying drawings.

### BRIEF DESCRIPTION OF THE DRAWINGS

FIG. 1 is a depiction of an HLA A2 molecule and epitopes. The epitopes are positions or combinations of positions on the molecule against which antibodies are produced. Antibodies with the noted specificities will react with the designated epitopes.

FIG. 2(a) depicts an example of results obtained from a single antigen bead test; FIG. 2(b) depicts resulting specificities and amino acid positions that were identified as the epitope; FIG. 2(c) depicts the position of the epitope on the HLA molecule.

FIG. 3 is a table showing sixteen of the 84 variable amino acid positions for seventeen different alleles.

FIG. 4 is a table showing fourteen of the 290 position/amino acids and some of the 77 possible associated alleles.

FIG. 5 is a table depicting combination of a first table entry (for position/amino acid 009/phenylalanine) with the other entries in the table (001/S through 031/S are shown in FIG. 5).

FIG. 6 is a table showing the combined allele list for a set of first positions/amino acids and a set of second positions/amino acids for the positions/amino acids combined in FIG. 5.

FIG. 7 is a table depicting combination of a second table entry (for position/amino acid 009/tyrosine) with the other entries in the table (001/S through 031/S are shown in FIG. 7).

FIG. 8 is a table showing the combined allele list for a set of first positions/amino acids and a set of second positions/amino acids for the positions/amino acids combined in FIG. 7.

FIG. 9 is a table depicting combination of a third table entry (for position/amino acid 009/serine) with the other entries in the table (001/S through 031/S are shown in FIG. 9).

FIG. 10 is a table showing the combined allele list for a set of first positions/amino acids and a set of second positions/amino acids for the positions/amino acids combined in FIG. 9.

FIG. 11 is a table depicting combination of a fourth table entry (for position/amino acid 009/threonine) with the other entries in the table (001/S through 031/S is shown in FIG. 11).

FIG. 12 is a table depicting combination of a fifth table entry (for position/amino acid 009/aspartic acid) with the other entries in the table (001/S through 031/S is shown in FIG. 12).

FIG. 13 is a table depicting combination of a sixth table entry (for position/amino acid 009/histidine) with the other entries in the table (001/S through 003/S is shown in FIG. 13).

FIG. 14 is a table depicting combination of a seventh table entry (for position/amino acid 011/serine) with the other entries in the table (001/S through 031/S is shown in FIG. 14).

FIG. 15 is a portion of a two-position table showing the combined allele list for alleles having phenylalanine at position 009.

FIG. 16(a) is a bar graph showing the reaction strength from single antigen bead testing for monoclonal antibody designated MAb F119-9F4E7; FIG. 16(b) depicts resulting specificities and amino acid positions that were identified as the epitope; FIG. 16(c) depicts the position of the epitope on the HLA molecule; FIG. 16(d) shows the position on the HLA molecule of the epitope having leucine at position 109 and arginine at position 131 and the associated allele list.

FIG. 17 is a two-position table that includes the combined allele list for alleles having leucine at position 109 and arginine at position 131.

FIG. 18 is a table depicting combination of a first entry of a two-position table (for positions/amino acids 009/phenylalanine and 031/threonine) with the other entries in the table (032/Q through 056/E is shown in FIG. 18).

FIG. 19 is a table depicting combination of a second entry of a two-position table (for positions/amino acids 009/phenylalanine and 035/arginine) with the other entries in the table (032/Q through 056/E is shown in FIG. 19).

FIG. 20 is a table depicting combination of a third entry of a two-position table (for positions/amino acids 009/phenylalanine and 044/arginine) with the other entries in the table (032/Q through 056/E is shown in FIG. 20).

FIG. 21 is a three-position table showing the combined allele list for sets of first, second and third positions/amino acids for the positions/amino acids combined in FIG. 20.

FIG. 22 is a graphic showing the position on the HLA molecule of an epitope having lysine at position 144, arginine at position 145 and histidine at position 151.

FIG. 23 is a two-position table that includes the combined allele list for alleles having lysine at position 144, arginine at position 145 and histidine at position 151.

FIG. 24 is a bar graph showing reaction strength plotted for each of a set of single antigen bead specificities. The results were found to be a combination of two antibodies, with the resulting specificities being a combination of the specificities of the individual antibodies.

FIG. 25 is a sample of a computer screen, for a test program for selecting multiple antibodies, to run the specificities showing a positive reaction in FIG. 24.

FIG. 26 depicts a best-match search through a three-position table showing a best-match for six of the nine alleles from FIG. 25.

FIG. 27 depicts a best-match search through a three-position table showing a best-match for the remaining three of the nine alleles from FIG. 25.

FIG. 28 is table showing specificities having glycine at position 62 and specificities having threonine at position 142.

FIG. 29 is a sample of a computer screen to run the specificities, A2, 2, 11, 24 and 36.

FIG. 30 is a table showing positions/amino acids for specificities A1, 3, 11, 24 and 36 and the best fit.

FIG. 31 is a is a table showing a three-position table for specificities A1, 3, 11, 1102, 24, 2403 and 36.

FIG. 32 depicts the position of the epitope on the HLA molecule for two amino acids.

FIG. 33 depicts the position of the epitope on the HLA molecule for three amino acids.

FIG. 34 is a flow chart summarizing construction of single-position tables to two- and three-position tables and listing probable epitope candidates.

FIG. 35 is a table showing an example of using average values of the reaction strength (fluorescence intensity in this example) against multiple negative controls to determine individual bead-dependent negative variability values.

FIG. 36 is a table showing an example of using individual correction factors and adjustment of bead-dependent negative variability, for the measured reaction strength of specific beads for a given sample, to determine relatively equivalent positive fluorescence.

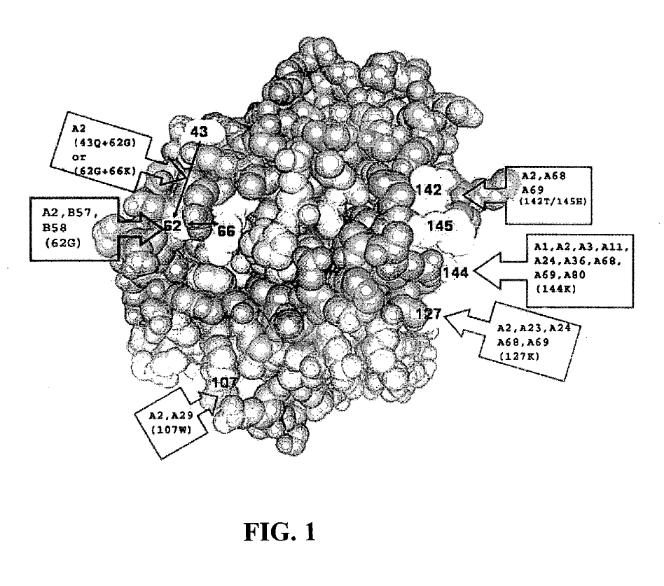

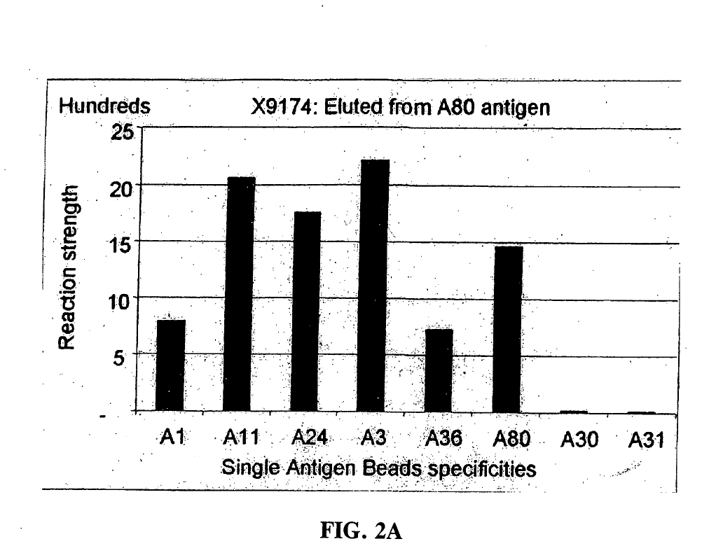

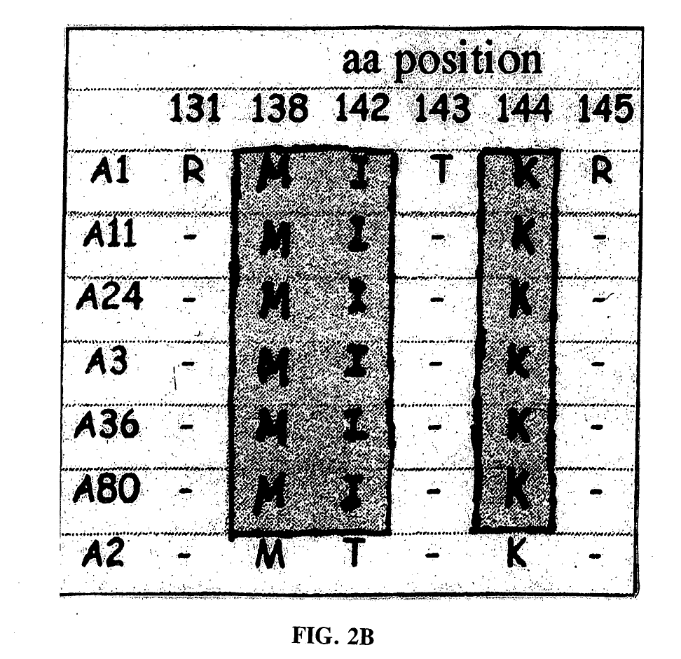

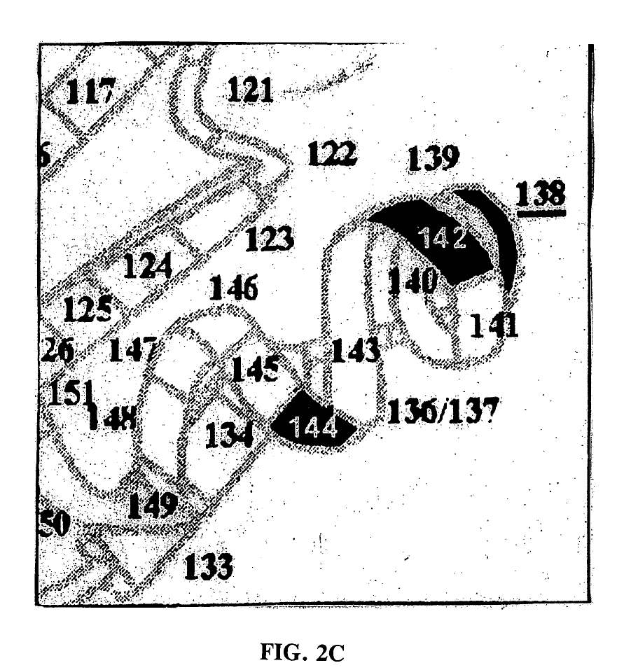

### DESCRIPTION OF THE PREFERRED EMBODIMENT(S)

The detailed description set forth below in connection with the appended drawings is intended as a description of presently preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The methods, kits and computer software disclosed herein identify probable epitopes, such as for example HLA epitopes, and thereby their specificities or antigens, preferably by examining all possible variations in the amino acid sequence of the antigens in question and constructing data tables of that information. Data tables of possible combinations of amino acids, preferably up to six locations, may then be searched for the best fit combinations. In a preferred embodiment of the invention, multiple steps in constructing and using the tables are carried out to determine all possible epitopes. In the preferred embodiment, the resulting group of tables represents all possible epitopes specific to a set of single antigens. Each of the possible epitopes is preferably identified with the associated specificities (or the list of antigens that are expected to react against epitope).

For example, the method may comprise a first step of constructing a listing of amino acid sequences which are a subset of amino acid sequences containing only the sequences of all antigens present in the single antigen beads (or other single antigen product). A next step is preferably carried out, in which non-variable single amino acid positions are eliminated. From each of the variable amino acids within each variable position, a data table of antigens that share the same position/amino acid combinations may be compiled. The resulting one-position table of the one-position amino acid combinations with the associated antigen list preferably comprises the first of the group of tables that are constructed.

In the preferred embodiment, two-position tables may be built from the one-position table by making every combination of two one-position table entries. Likewise, three-position tables may be built by making every combination of three one-position table entries, preferably on up to six-position tables. Alternately, three position-tables may be constructed by combining the results for a two-position table and a one-position table. This group of tables preferably represents all possible epitopes specific to the single antigen beads (or other single antigen product). Each epitope will have associated specificities. The group of possible epitopes is preferably edited to delete epitopes not associated with any specificities and those associated with all specificities.

A step to identify the first antibody is also preferably performed. This may be done by either observing where a measured parameter, such as for example, a measured fluorescence strength level, drops off, or by using some other grouping method, such as grouping of single-antigen beads (or other single-antigen product) by selecting those producing higher measured values than a cut-off value, such as, for example, those producing higher measured fluorescence values than a cut-off value.

A third step preferably involves searching the tables for a match with the first antibody. From the tables, the first position/amino acid combination covering the largest number of specificities from the original list, without including any other specificity not present in the same list, is selected.

An additional step may be performed, which involves splitting the original group defining the antibody into smaller groups where the epitopes found cover a short list of the original. The remainder may be processed as a separate group.

When the initial attempt of searching for a single epitope that matches the antibody specificities is not successful, a stepwise search of multiple epitopes which fit with the original list of specificities from the selected group of beads as an aggregate may be performed using the constructed table.

From the tables, the first position/amino acid combination covering the largest number of specificities from the original list, without including any other specificity not present in the same list, is selected.

The next position/amino acid combination is selected to provide maximum coverage of the remaining specificities. This stepwise selection of the epitopes yields the cumulative best fit to the combined specificities of the selected epitopes to those in the original list in the defined group.

Further steps involving separate cycles of stepwise selection of epitopes to yield the best cumulative fit of specificities to those represented by the subsequent groups may be performed.

Additional steps for measurement, outlier assessment/central value statistics, a normalization process, an analysis of sample-dependent negative variability, analysis of positive reaction strength variability, as well as steps for forming a list of specificities, building the specific tables and table size reduction may also be preformed.

For example, the steps of measuring the specific antigen beads (or other single-antigen product) and measuring the reaction strength in a sample may be performed. These steps may be carried out, for example, by measuring two steps of fluorescence intensity values for each antigen bead (or other single-antigen product) sampled. Measurements are preferably taken until the system satisfies a pre-set condition. Each measurement may be summarized by computing, for individual antigen bead numbers, the various statistics to indicate central values (median, mean, trimmed peak, peak etc.), variability measurements (standard deviation, cv etc.) and the sample count (trimmed or standard).

The present invention may also comprise an outlier assessment/central value statistics step. For example, the measuring device or system may be set up to handle multiple samples one after another and preferably there will be expected numbers of carry over beads from one sample to another. In the case where two neighboring samples may show opposite reactions, the first one positive and the second negative (or the opposite), for example, the measurements from the carried over beads become outliers and are preferably neutralized. The central value statistics most stable to the variable number of single sided outliers is median.

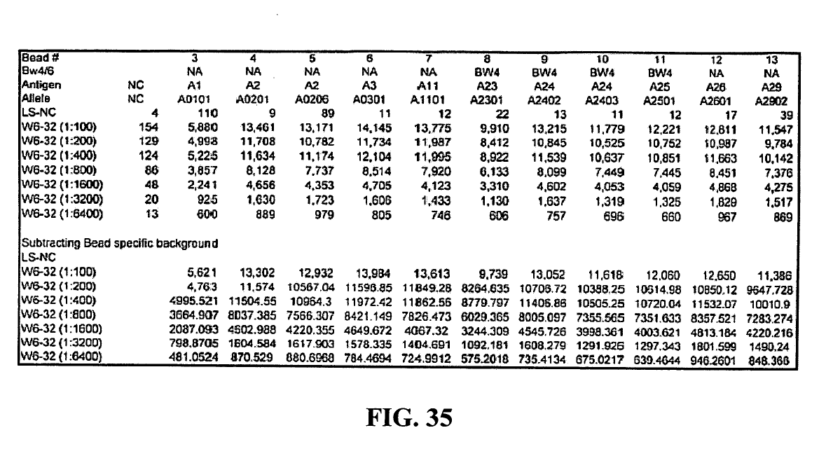

In addition, generally, there could be slight variations on how individual beads is behave against the negative samples. Therefore, a normalization step addressing bead-dependent negative variability may also be performed. In this step, individual background values for each bead may be measured from running multiple negative controls and obtaining the resulting measurements. Average values of the reaction strength (for example, fluorescence intensity) against multiple negative controls may be used to indicate individual bead-dependent negative variability values. Preferably, relatively even negative fluoresce intensity (or other suitable measurement) will be obtained across all negative beads within each sample after the bead dependent values are subtracted. An example is demonstrated in the table shown in FIG. 35.

A sample-dependent negative variability step may also be performed to further enhance accuracy of the measured reactions. In this step, individual sample-specific negative values that may vary are preferably measured by the negative control bead (typically designated bead 001) reaction intensity.

In addition, a positive reaction strength variability step may be performed. In this step, variability among beads is preferably normalized by measuring the strength of each antigen bead's reaction against positive controls. For example, a positive control that is expected to produce a positive reaction against all antigen beads is run against each antigen bead in the product.

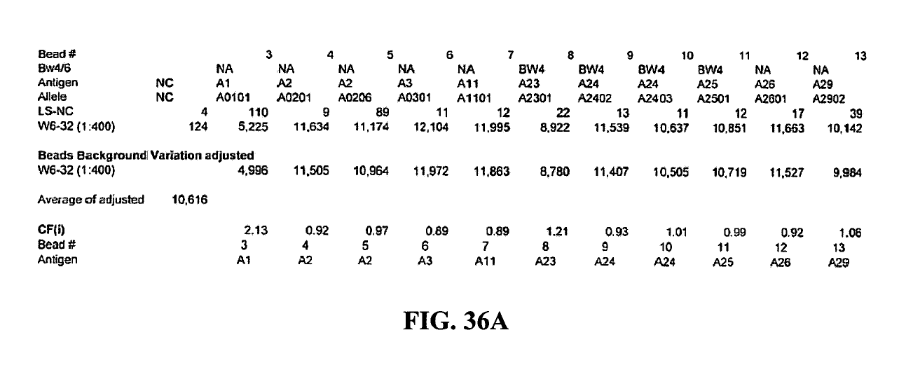

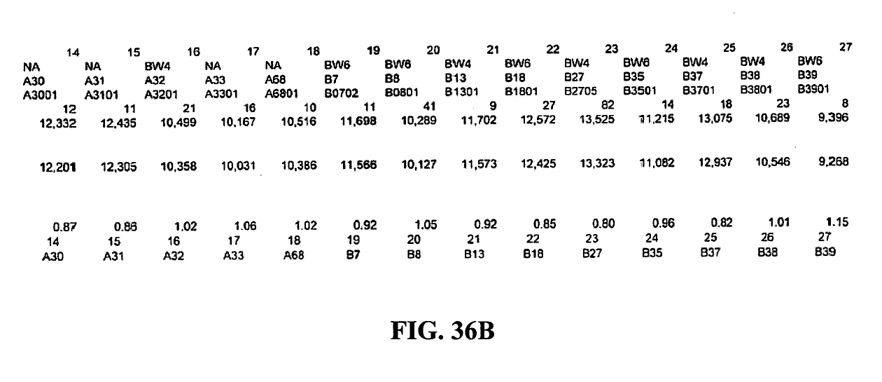

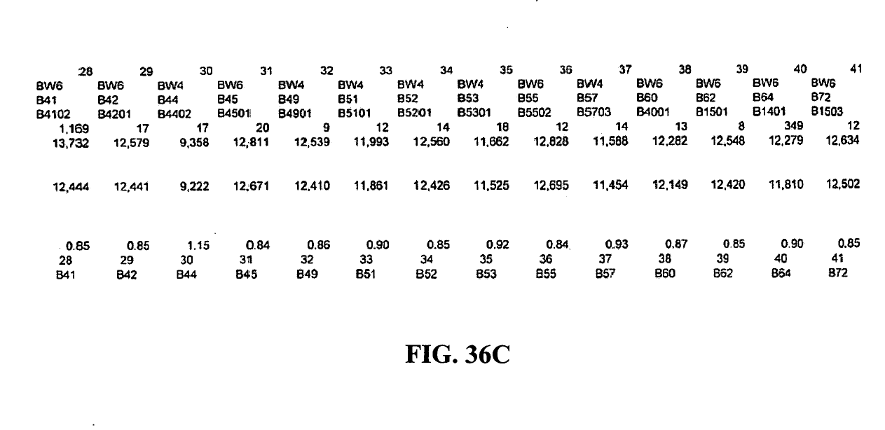

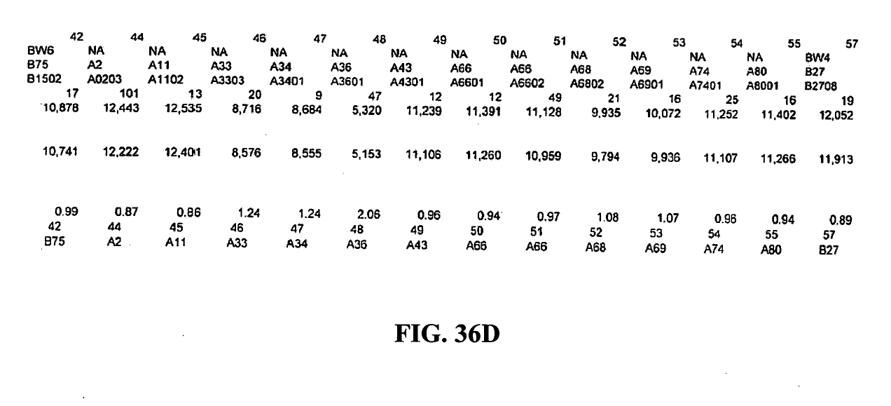

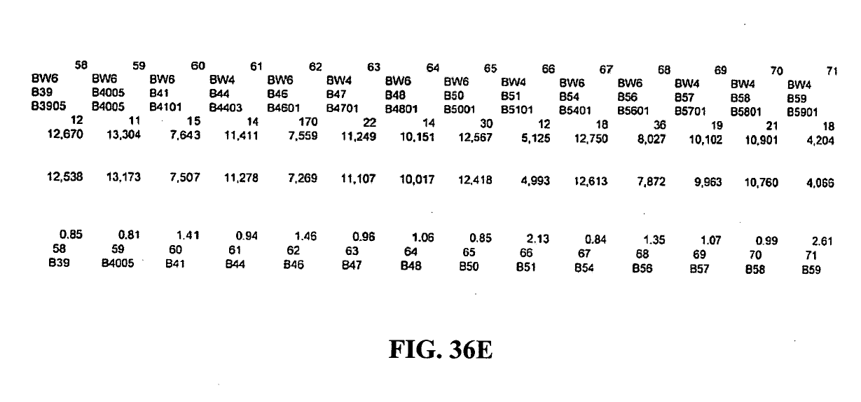

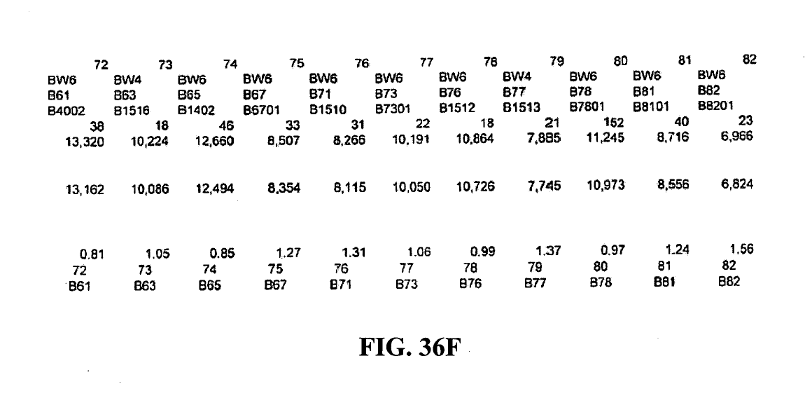

The sample-dependent negative variability step and the positive reaction strength is variability step may be used to calculate individual correction factors. For example, the individual correction factors, CF(i), for the variation of the strength of the reaction for each bead (i) (after the adjustment of bead-dependent negative variability) may be computed against the overall average of reaction strength of the positive reactions. An example is demonstrated in the table shown in FIG. 36. After accounting for the negative variability and applying correcting factors CF(i) for each of measured reaction strength of specific beads (bead (i)) for a given sample, the relatively equivalent positive fluorescence intensity from each bead may be determined. Any significant deviation in the observed positive reaction intensity compared to other positives may indicate the presence of multiple reactions (i.e. multiple antibodies). Bead or other products employing molecules of equivalent soluble fluorochrome (MESF) may also be used, and the reaction strength expressed as a MESF value or normalized percent value defined by MESF values derived from positive and negative control samples. For example, MFI values may be converted to MESF values and then normalized using the working range of MESF values for a negative reaction as 0% and the MESF values for a positive reaction as 100%.

If there is only one antibody present, two groups of reactions are expected by the reaction strength: an even level positive strength reaction, and the other an even level negative. If there are more than two groups of reaction levels, further analysis may be done to determine whether there is more than one antibody present.

For each of the positive signal group, a list of specificities may be formed from the positive antigen beads in the group. A positive reaction for a given bead indicates the presence of the associated specificity. Each determined specificity may then be compared to the table built for the single antigen beads (or other single antigen product) to identify possible epitopes.

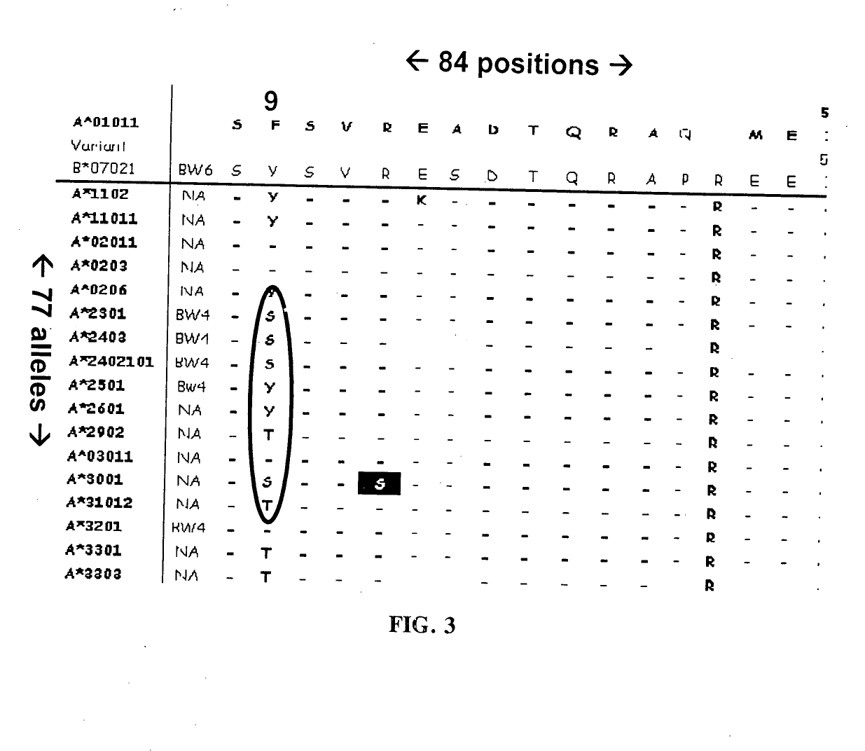

In the preferred embodiment, the data table size is significantly reduced by working with specific single antigen beads or other single antigen products. The observed list will preferably only include those specificities from the specific antigen bead product, thereby eliminating from the data table those alleles not part of the antigen bead product. In the preferred embodiment, there are 77 alleles present for the class I antigen bead product and 22 for the Class II antigen bead product, 10 for the MICA antigen bead product, and the table sizes are reduced accordingly. The entries in the table preferably consist of one or more specific positions/amino acid sequences and their associated specificities (see for example, FIG. 3). The entries are preferably generated by combining the single position/amino acid sequence information with the list of alleles who share the particular position/amino acid.

The first data table, preferably comprising all possible unique single-position/amino acid combinations, may then be used to build pair-wise lookup tables to find distinct unique combinations. For example, a second table preferably comprising all two-position unique position/amino acid combinations and a third table preferably comprising all three-position unique position/amino acid combinations may be constructed in this manner. The constructed tables may then be used to search for a “best match” and to list probable epitope candidates. Example I sets forth an example protocol:

### EXAMPLE I

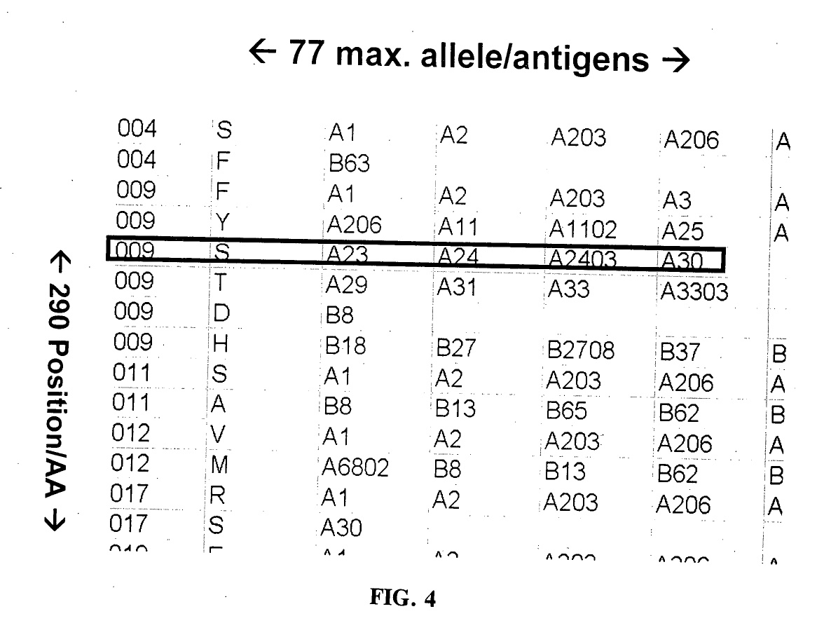

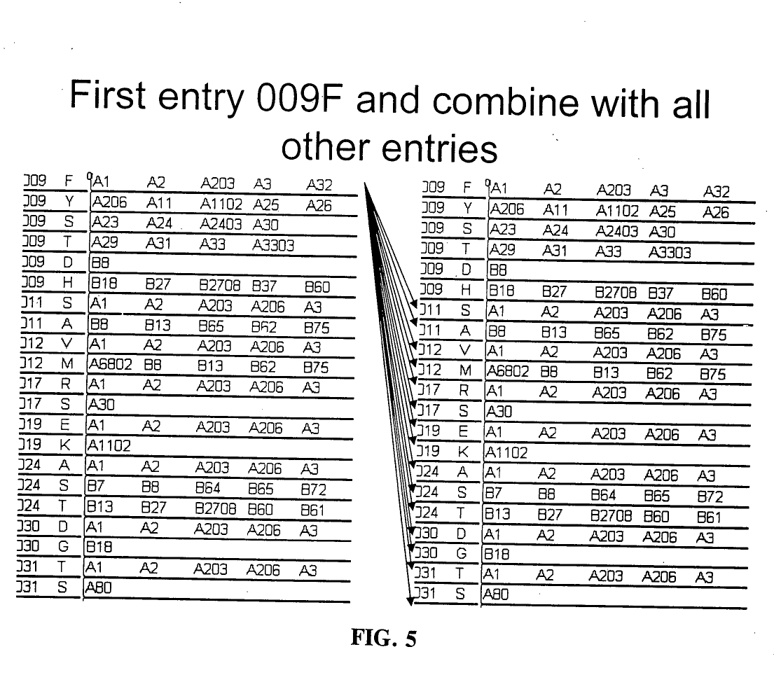

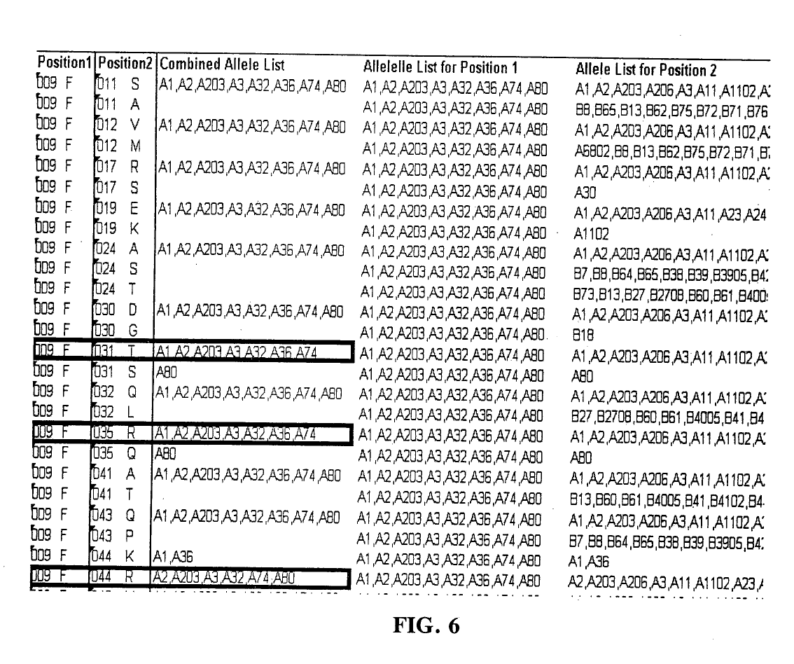

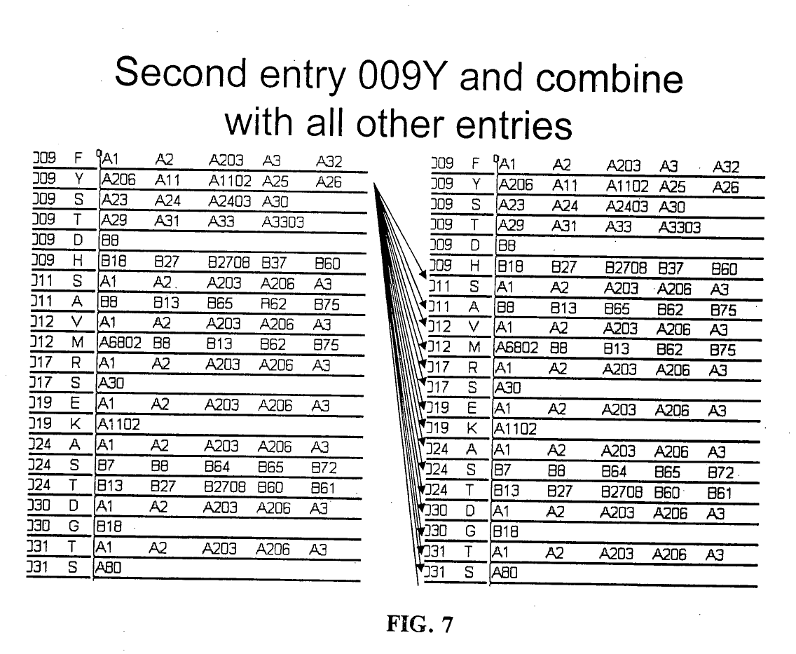

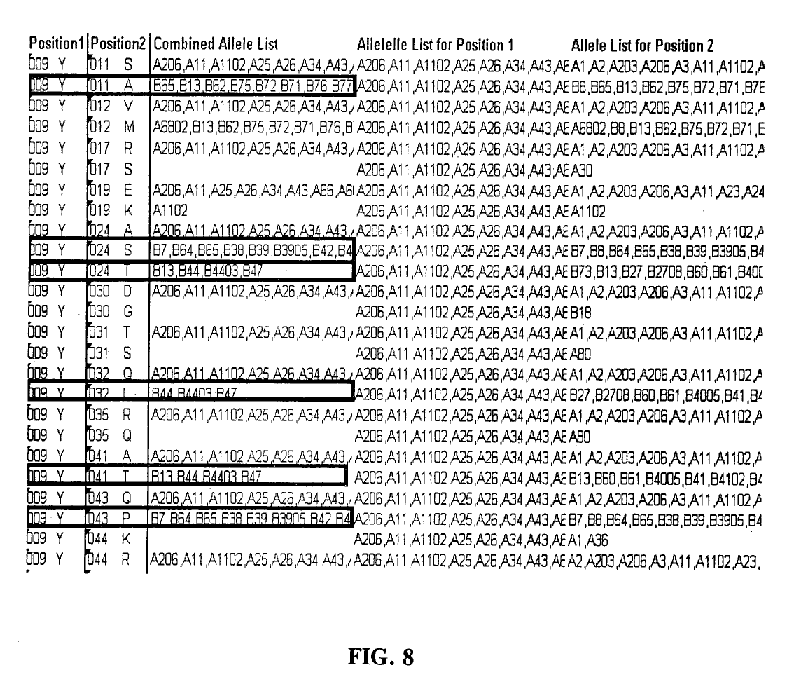

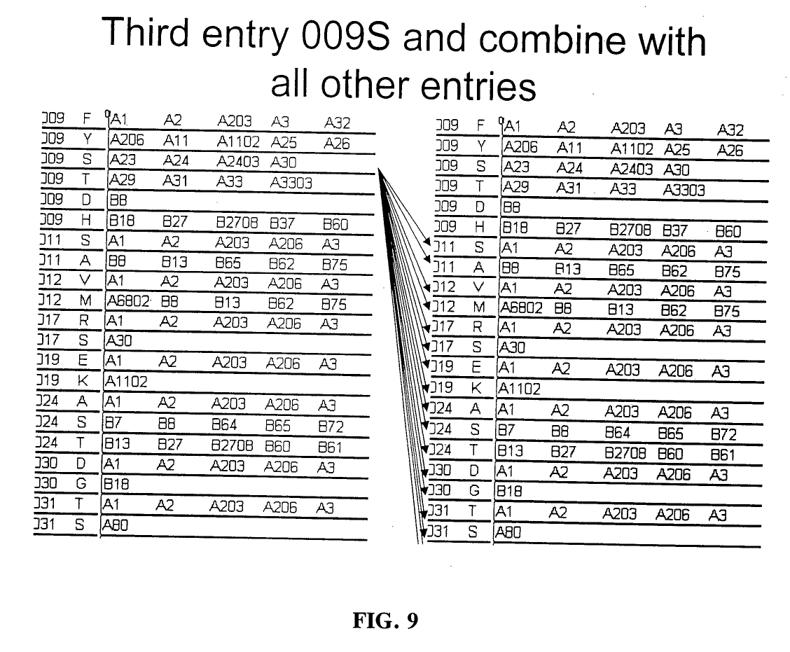

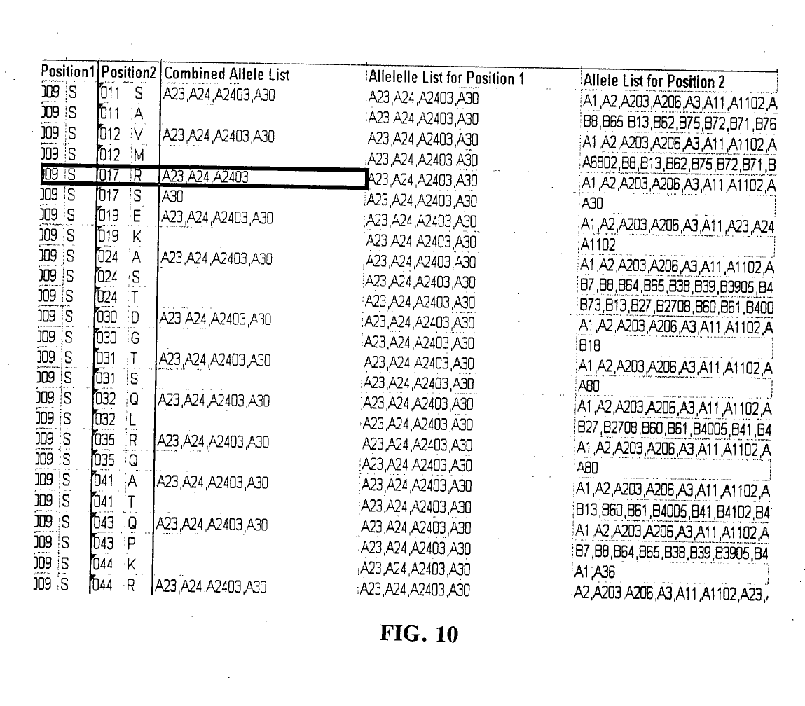

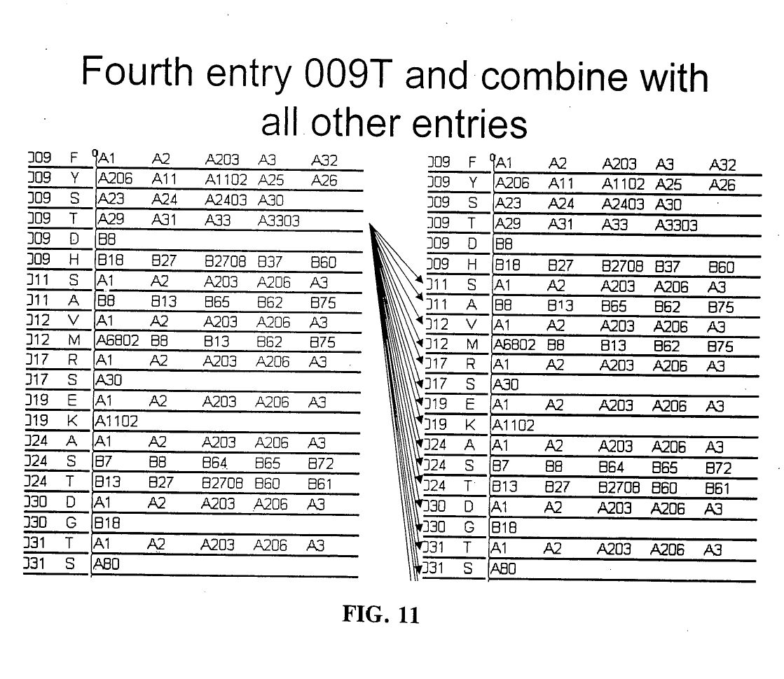

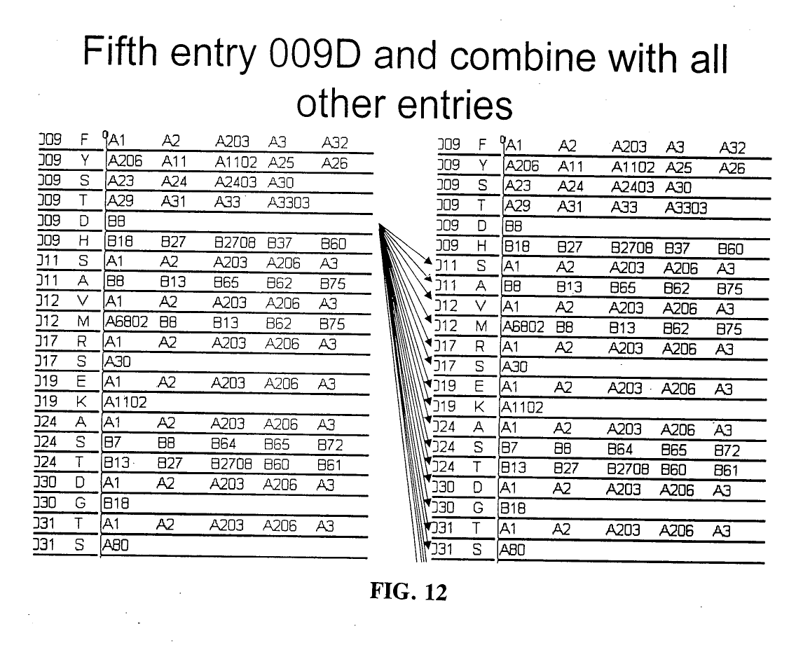

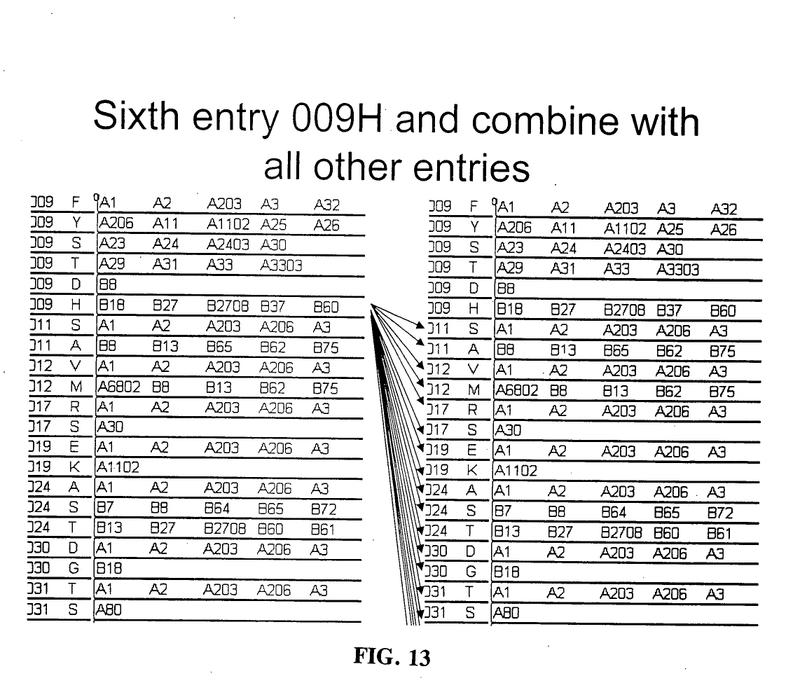

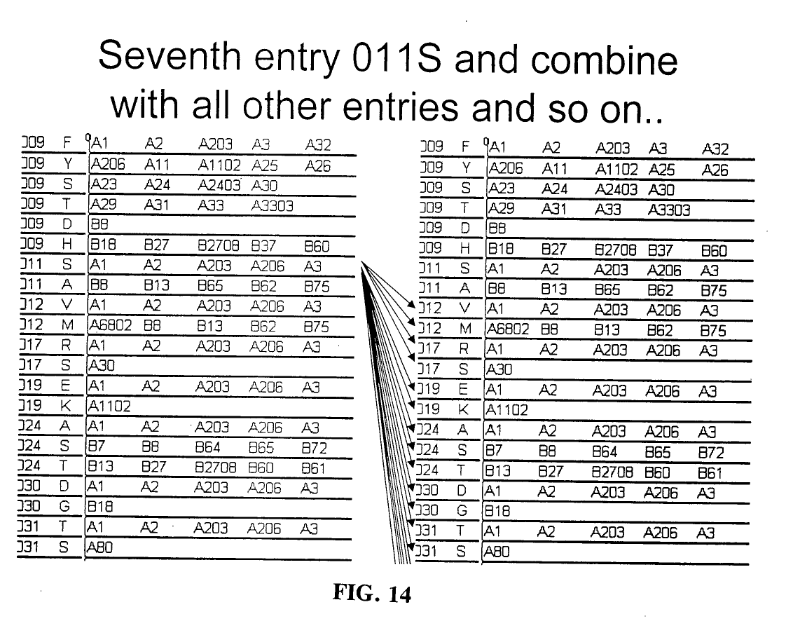

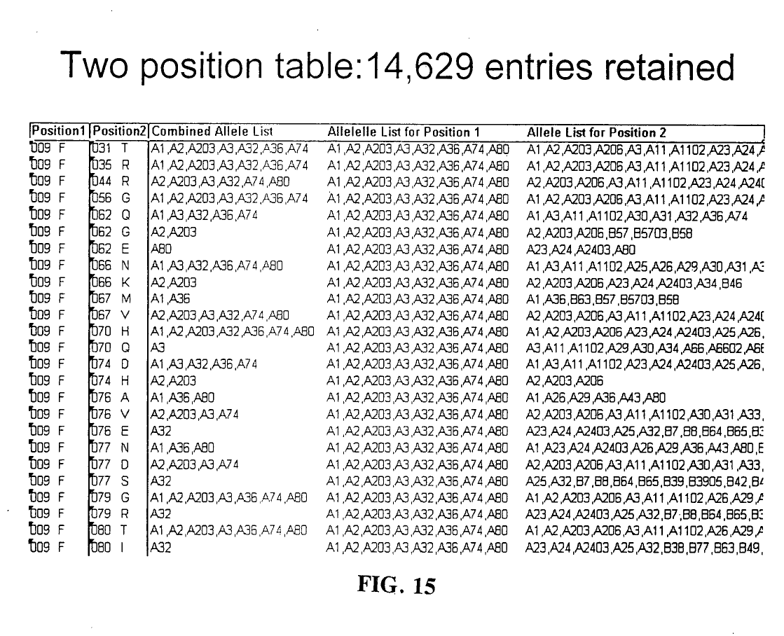

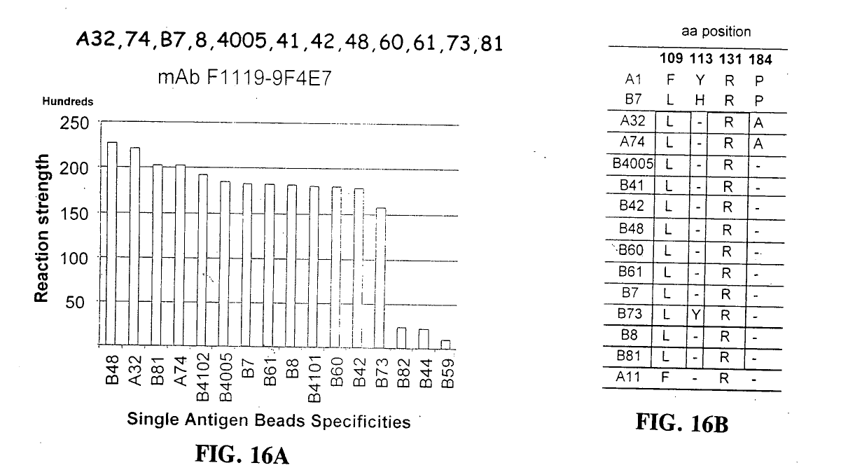

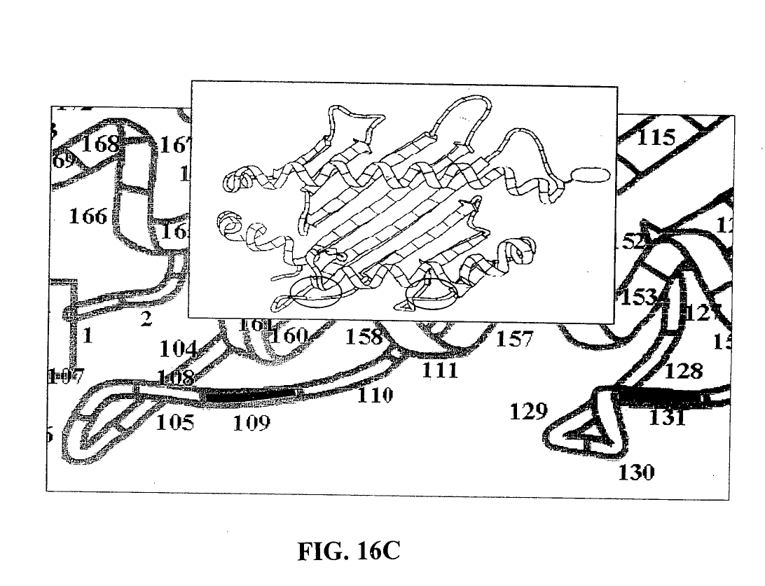

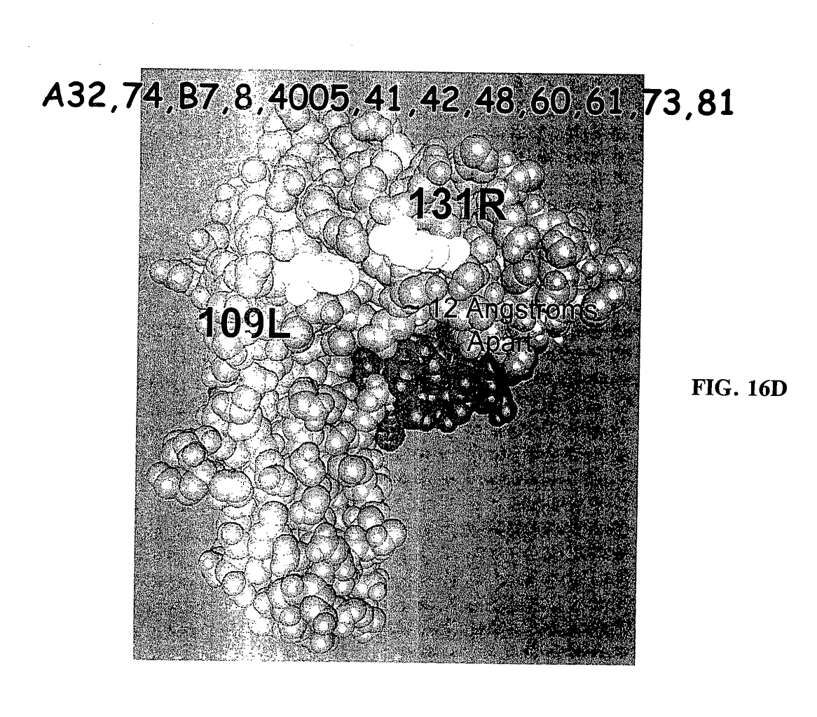

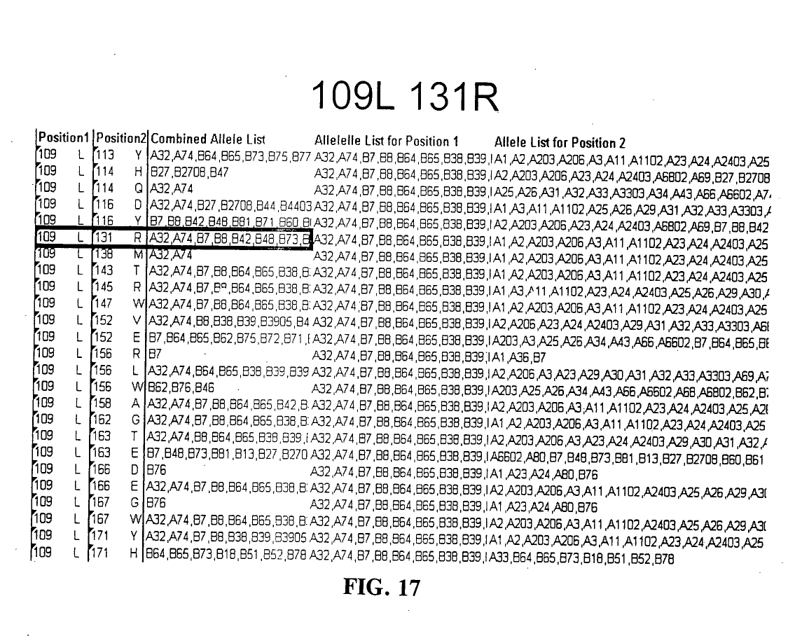

1. Construct a single-position table of possible polymorphic sites of HLA Class I alleles defined by using single-antigen beads. This results in a total of 290 entries (see, FIGS. 3-4).
2. Build the two-position/amino acid table. Combining every 2 entries from the one-position/amino acid table comprising 290 entries will mathematically produce 41,905 combinations (see FIG. 5).
3. The resulting two-position list comprises the amino acid associated with each of the two positions and a combined allele list obtained from combining the allele list for position 1 and the allele list for position 2 (see e.g., FIG. 6). In this example, a first entry, 009F (phenylalanine at position 009) is combined with all other entries and the resulting combined allele list from entries 001S (serine at position 011) through 044R (arginine at position 011) are shown in FIG. 6. FIG. 7 is a representation of combining the second entry, 009Y (tyrosine at position 009), with the other entries. The list shown in FIG. 8 shows a combined allele list obtained from combining the allele list for position 1 (tyrosine at position 009) and the allele list for the other entries in position 2 (011S through 044 R are shown in FIG. 8). Likewise, FIG. 9 shows combination of the third entry, 009/S (serine at position 009) with the other entries, resulting in a combined allele list obtained from combining the allele list for position 1 (serine at position 009) and the allele list for the other entries in position 2 (011S through 044 R are shown in FIG. 10). Lists for combining the fourth through seventh entries (009/T, 009/D, 009/H and 011/S) are shown in FIGS. 11-14.
4. After combining eliminate: 1) pairs having amino acids from the same position; 2) pairs that are further apart than 40 positions/amino acids; 3) pairs that do not gain an additional allele by combining; 4) pairs that do not share a common allele. The two-position table contains 14,629 entries (see e.g., initial entries shown in FIG. 15)

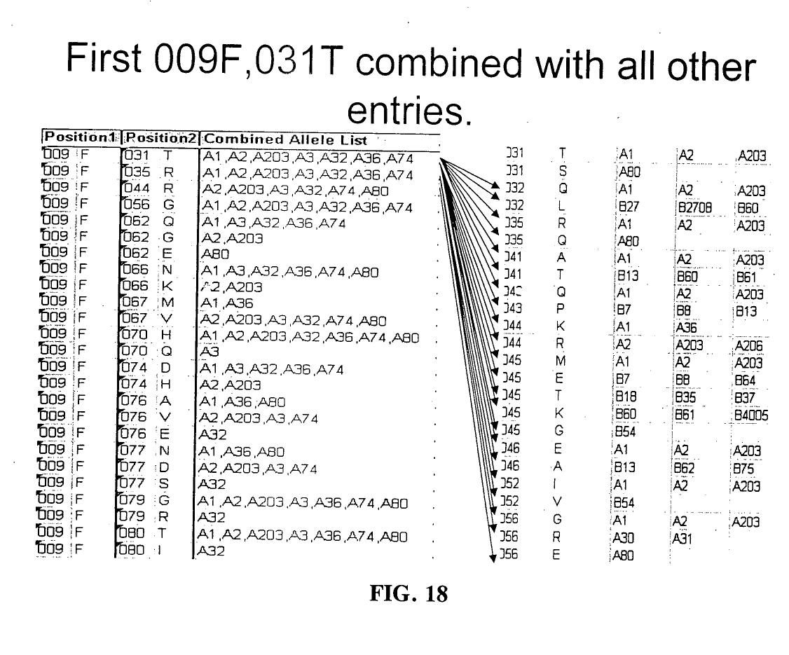

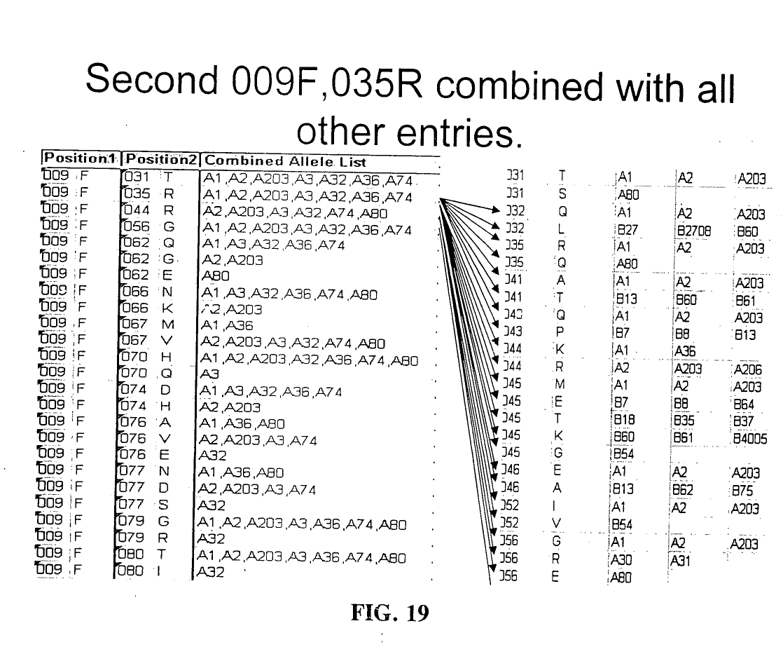

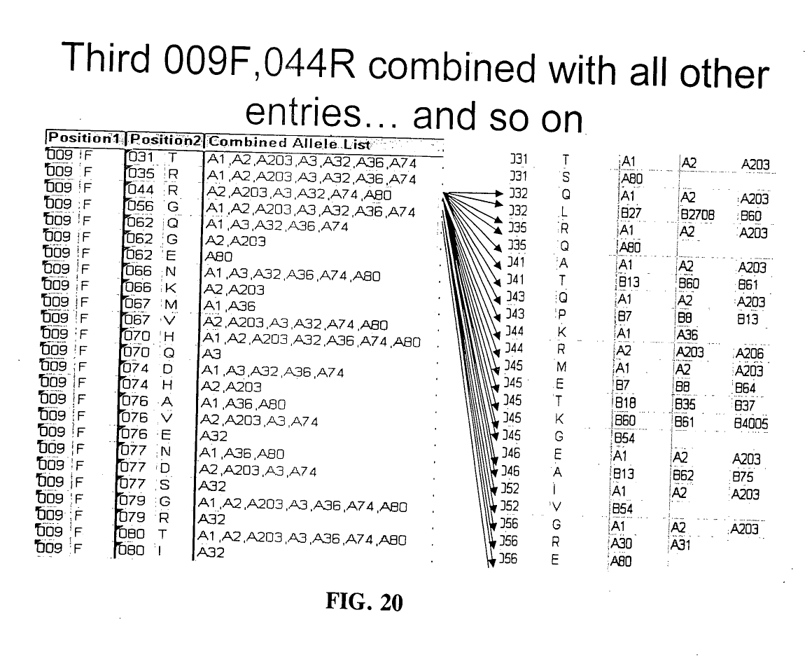

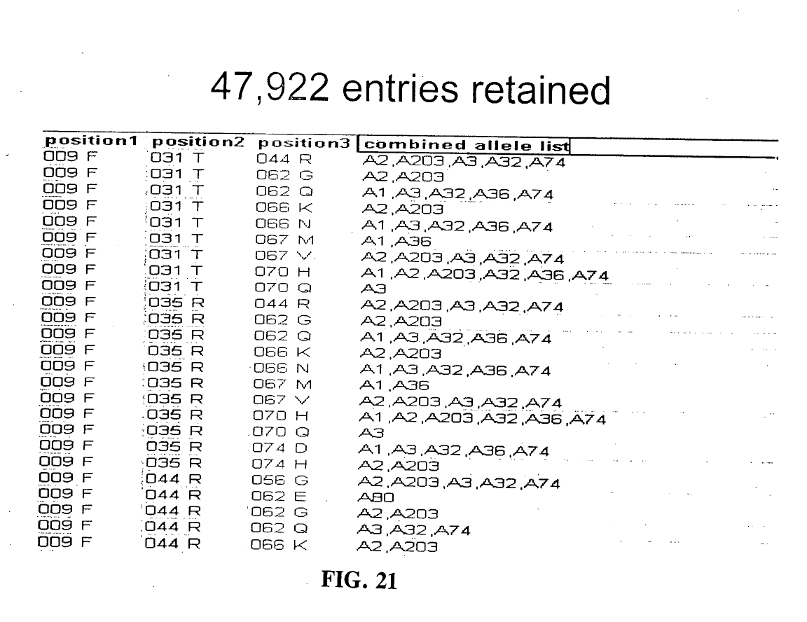

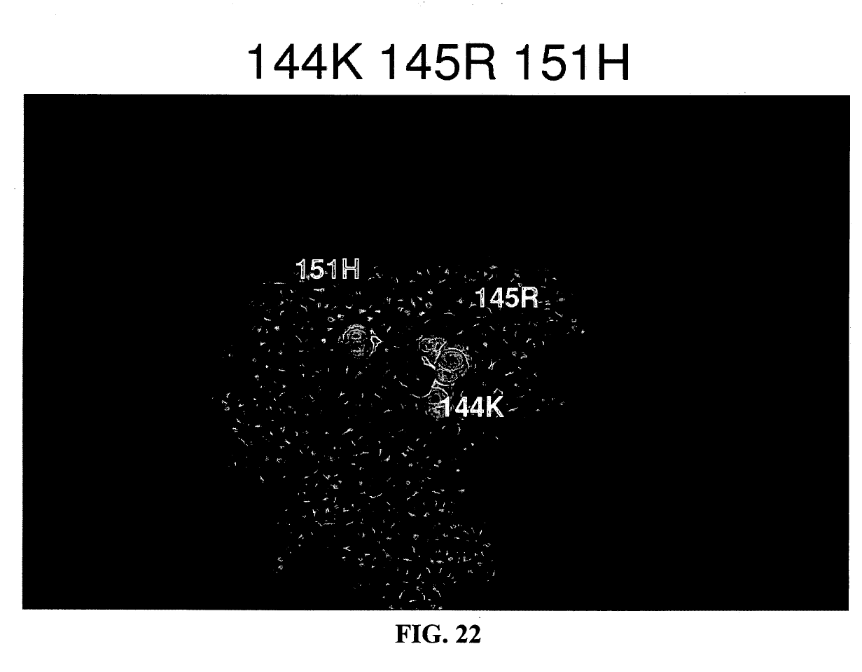

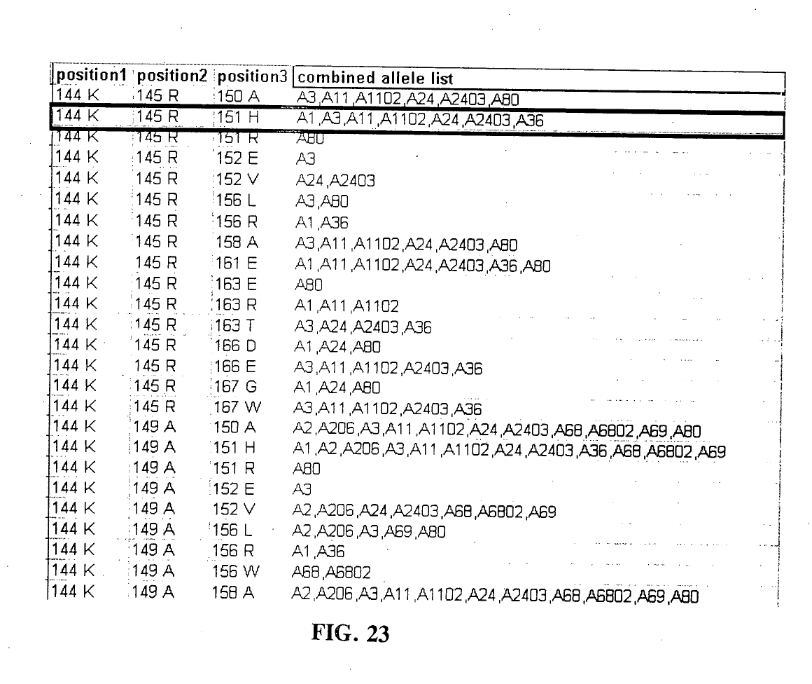

5. A three-position/amino acid table is constructed. Every combination of three of the 290 entries from the single position/amino acid table will mathematically produce 4,022,880 combinations (see FIGS. 18-20) Eliminate: 1) entries where the three amino acids are in the same position; 2) any combinations of three that contain pairs that are further apart than 40 amino acid positions; 3) any combinations of three that do not gain an additional allele by combining; 4) any combinations of three that do not share any alleles. For a faster process, a two-position table may be combined with a single position table to produce the three-position table. After the eliminations, the three-position table contains 47,922 entries (see e.g., initial entries shown in FIGS. 21).
6. For a given string of specificities, search the three-position table and obtain a list of possible single residues to explain the reactions.

To further characterize observed antibody reactions where the initial attempt of searching for a single epitope that matches the antibody specificities is not successful, the results obtained from combinations of two or more different antibodies may be investigated. Based upon observed specificities in a sample, stepwise selections are made from one-, two- and three-position amino acid tables that yield the best fit without introducing additional alleles which are not in the original list. In combining multiple antibodies, the resulting specificities will be the combined specificities of individual ones. To simply the process, equal weight may initially be given to all the alleles in the list. Also, there may be some overlap in the specificities among multiple antibodies.

For example, Example 2 sets forth an exemplary method for selecting multiple antibodies.

### EXAMPLE 2

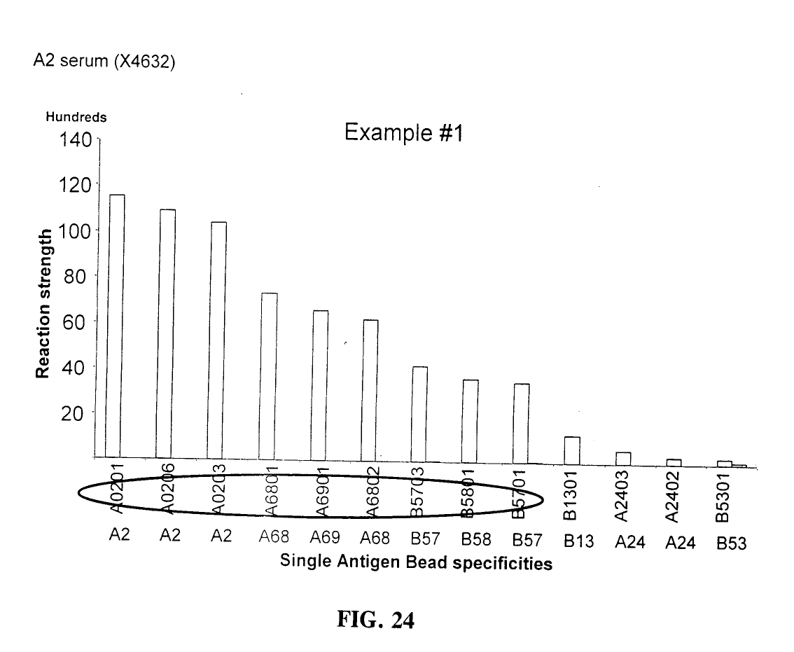

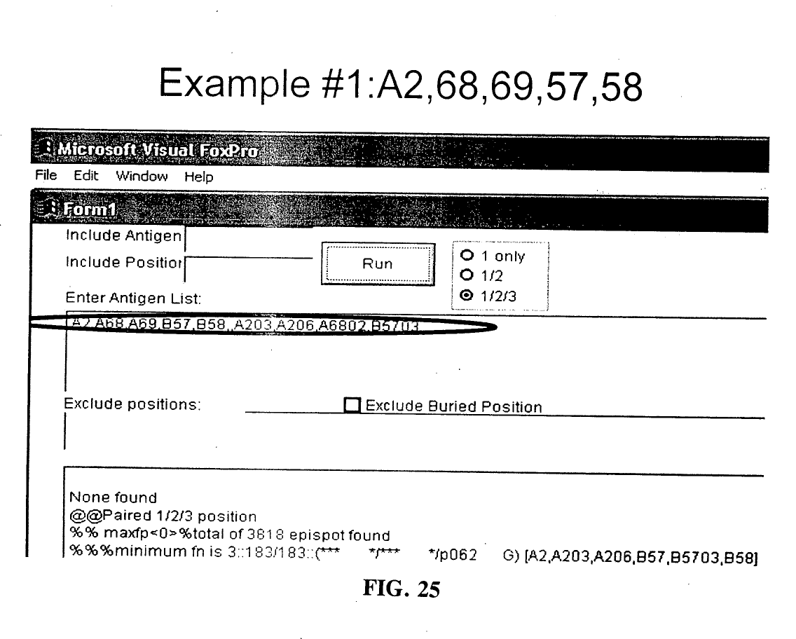

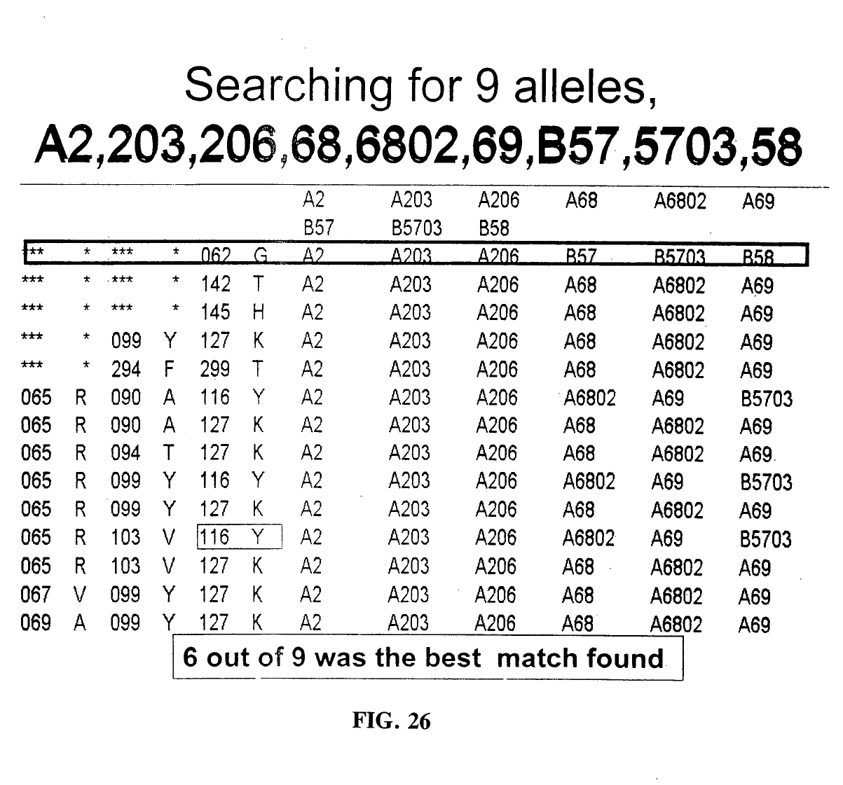

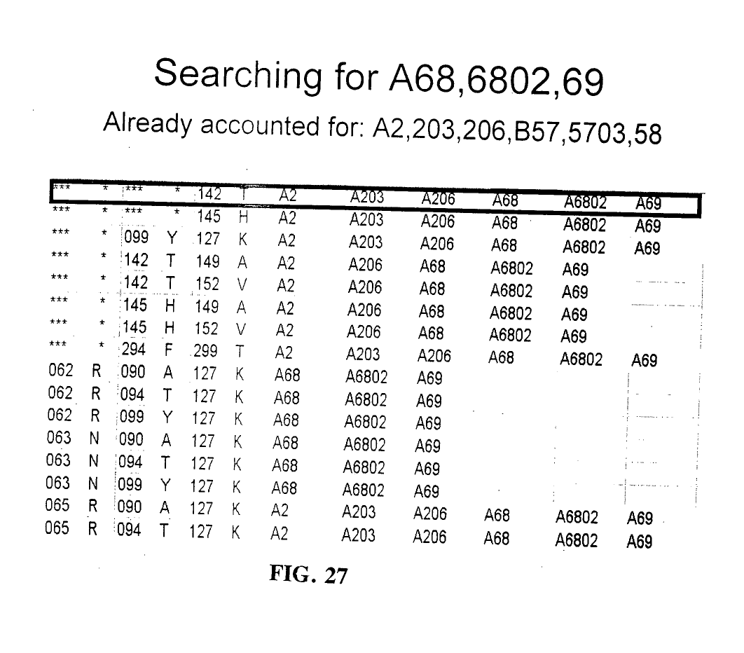

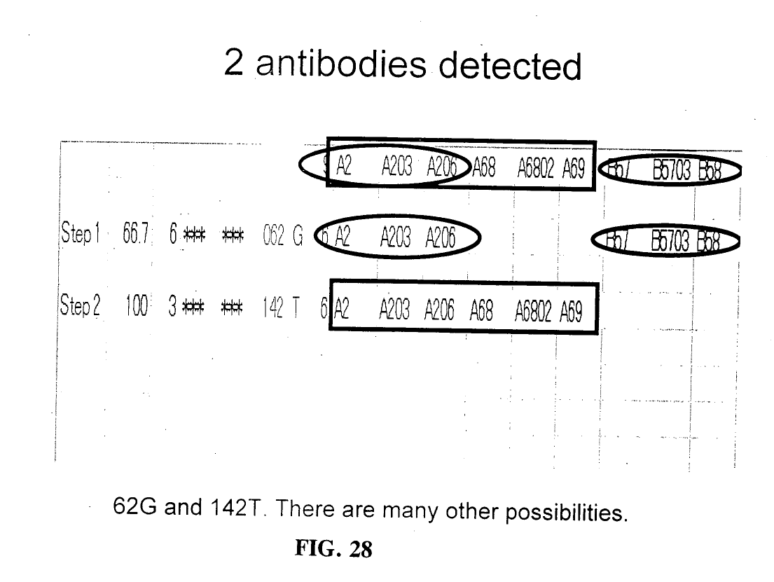

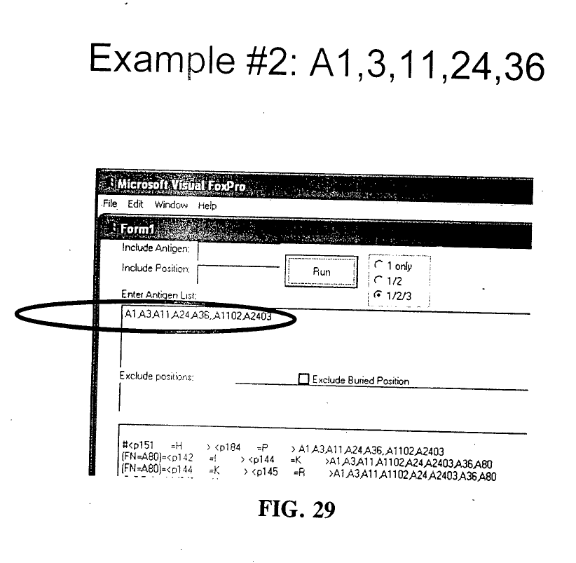

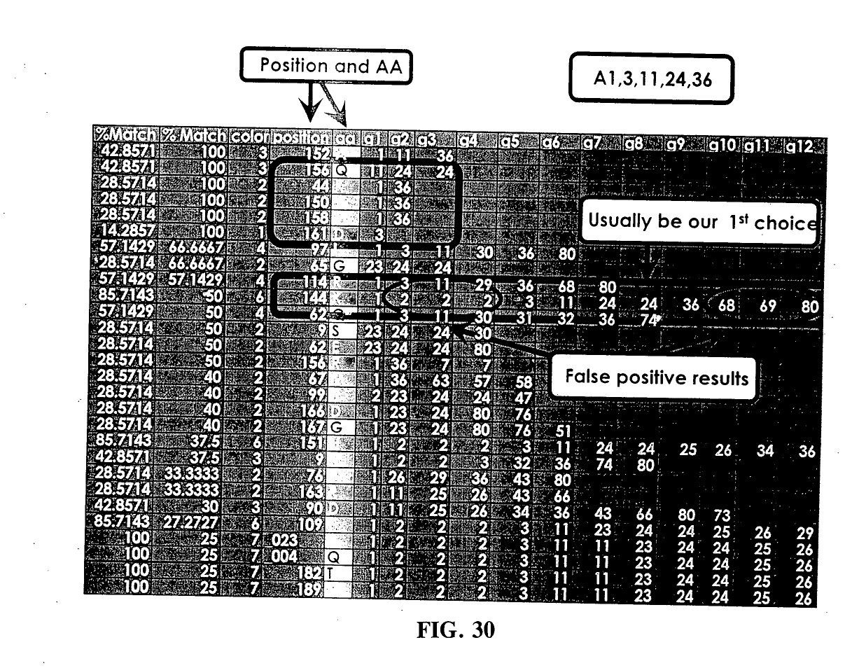

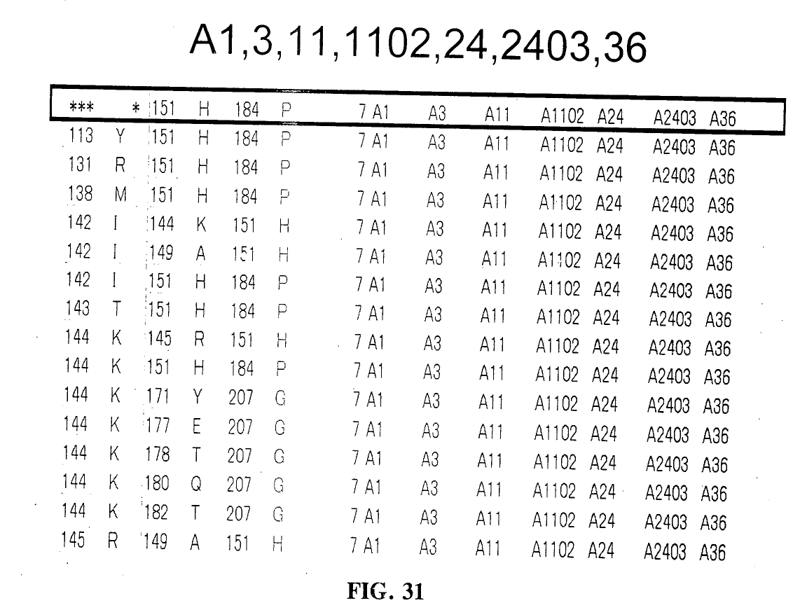

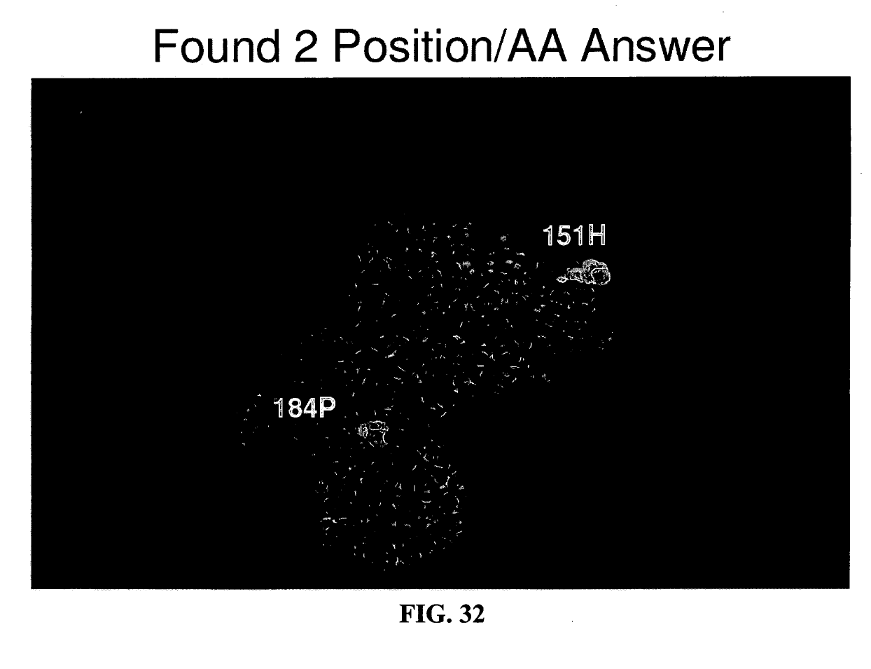

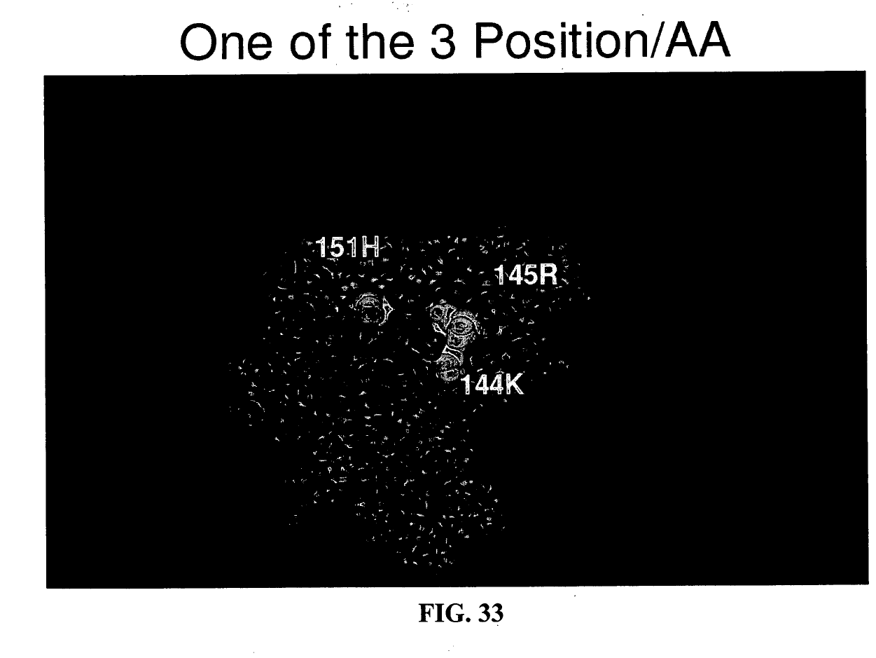

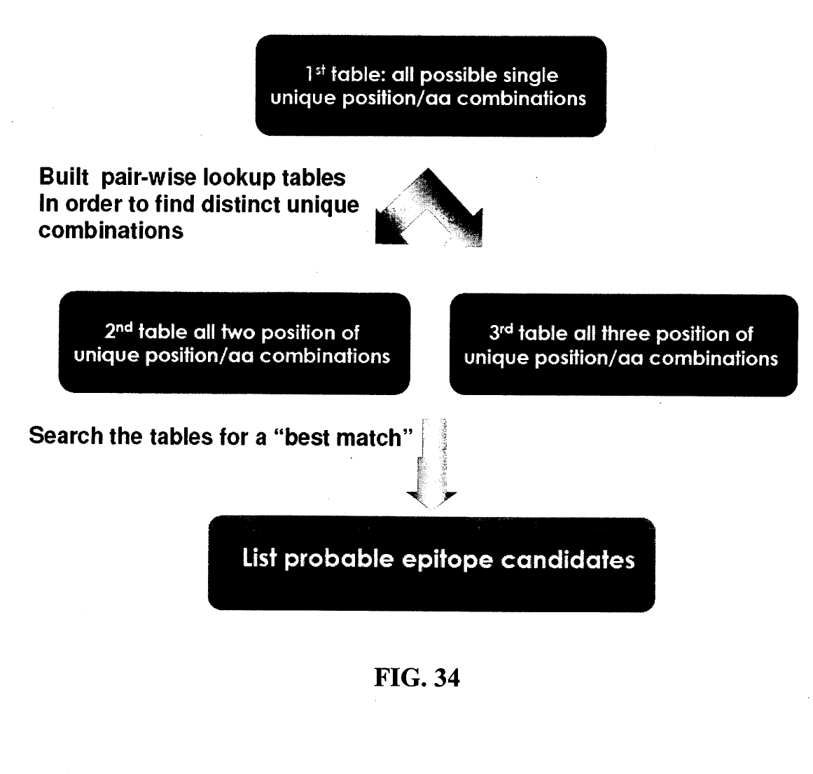

1. Positive reactions for specificities are determined for a set of single antigen beads by plotting reaction strength for each bead (see e.g. FIG. 24).
2. The group of specificities having a positive reaction, A0201, A0206, A0203, A6801, A6901, A6802, B5703, B5801 and B5701, are run through a stepwise determination for a best match (see e.g., FIGS. 25-26).
3. A best match for six of the nine specificities (A2, A203, A206, B57, B5703 and B58) was located (FIG. 26).
4. A best match for the remaining three specificities (A68, A6802, A69) was located (FIG. 27).
5. Two antibodies were detected (see, FIG. 28).

The methods, assay kits and computer software disclosed herein may also provide an option for users to specify which positions or which paired positions to exclude and other parameters may be used to reduce the number of possible epitopes. In addition a graphical interface, such as a three-dimensional graph, may be included to permit easier selection from the multiple possibilities.

While the present invention has been described with regards to particular embodiments, it is recognized that additional variations of the present invention may be devised without departing from the inventive concept.

1. A method to determine epitopes against which an antibody will react, said method comprising the steps of:
a. constructing at least one data table comprising all possible combinations of amino acids and their respective positions derived from the positions/amino acids of at least one known antigen;
b. identifying antigens with which the antibody reacts; and
c. searching the data table for a best match of the known at least one antigen to the antigens to which the antibody reacts, whereby the combination of amino acids/positions derived from the best match in the at least one data table corresponds to the epitope on the HLA molecule with which the antibody reacts.

2. The method of claim 1, wherein data table comprises the positions/amino acid combinations of multiple known antigens.

3. The method of claim 2, wherein the at least one data table excludes position/amino acid combinations that are not within a subset of amino acid sequences obtained from the multiple known antigens.

4. The method of claim 3, wherein non-variable single amino acid positions are eliminated.

5. The method of claim 4, comprising the further step of compiling a single-position table comprising antigens that share the same single amino acid/position combination.

6. The method of claim 5, comprising the further step of combining every position/amino acid entry in the single-position table with every other position/amino acid entry in the single-position table to construct a two-position table comprising pairs of positions/amino acids.

7. The method of claim 6, wherein the two-position table comprises a combined allele list for each resulting pair of positions/amino acids.

8. The method of claim 7, comprising the further steps of:
a. eliminating pairs from the same position;
b. eliminating pairs that are more than forty positions apart;
c. eliminating pairs that do not result in a gain of additional allele by combining; and
d. eliminating pairs that have no common alleles.

9. The method of claim 8, comprising the further step of identifying antigens recognized by the antibody.

10. The method of claim 9, wherein the antigens are identified using separately bound single-antigens.

11. The method of claim 9, wherein the antigens are identified using single-antigen beads.

12. The method of claim 9, comprising the further step of locating a best match of the identified antigens in the two-position table.

13. The method of claim 9, comprising the further step of combining every position/amino acid combination on the two-position table with every position/amino acid combination on the one-position table to construct a three-position table.

14. The method of claim 13, wherein the three-position table comprises a combined allele list for each resulting triplet of positions/amino acids.

15. The method of claim 14, comprising the further step of eliminating:
a. triplets having the same position;
b. triplets containing a pair further apart than forty positions;
c. triplets that do not gain an additional allele by combining; and
d. triplets that do not share any alleles.

16. The method of claim 15, comprising the further step of locating a best match of the known antigens in the three-position table to determine the epitope.

17. The method of claim 15, comprising the further step of combining each triplet of positions/amino acids in the three-position table with each position/amino acid combination in the single-position table to construct a four-position table.

18. The method of claim 17, comprising the further step of combining each set of four positions/amino acids in the four-position table with each position/amino acid combination in the single-position table to construct a five-position table.

19. The method of claim 18, comprising the further step of combining each set of five positions/amino acids in the five-position table with each position/amino acid combination in the single-position table to construct a six-position table.

20. The method of claim 15, comprising the further step of running specificities having a positive reaction through a first stepwise determination for a best match in the three-position table.

21. The method of claim 20, further comprising the step of performing a second determination for a best match for any specificities not included in the first stepwise determination for a best match.

22. The method of claim 21, comprising the step of determining the number of antibodies detected.

23. A method to determine HLA epitopes against which an antibody will react, said method comprising the steps of:
a. constructing a single-position table of possible polymorphic sites of HLA alleles defined by a single-antigen product;
b. combining every entry on the single-position table with every other entry on the single-position table to construct a two-position table of pairs of positions/amino acids;
c. compiling a combined allele list from the pairs on the two-position table;
d. eliminating pairs having amino acids in the same position;
e. eliminating pairs that are further apart than 40 positions/amino acids;
f. eliminating pairs that do not gain an additional allele by combining two entries from the single-position table;
g. eliminating pairs that do not share a common allele;
h. combining every entry on the single-position table with every entry on the two-position table to construct a three-position table comprising triplets of positions/amino acids;
i. eliminating triplets having three amino acids in the same position;
j. eliminating triplets containing pairs of positions that are further apart than 40 amino acid positions;
k. eliminating any triplets that do not gain an additional allele by combining;
l. eliminating any triplets that do not share any alleles;
m. compiling a combined allele list from the triplets on the three-position table;
n. determining the specificities with which the antibody reacts;
o. searching the three-position table for a best match to the specificities to which the antibody reacts; and
p. from the three-position table, determining the positions/amino acids of the epitope corresponding to the best match on the three-position table.

24. The method of claim 23, comprising the further step of running specificities having a positive reaction through a first stepwise determination for a best match in the three-position table.

25. The method of claim 24, further comprising the step of performing a second determination for a best match for any specificities not included in the first stepwise determination for a best match.

26. The method of claim 25, comprising the step of determining the number of antibodies detected.
